(19) United States
(12) Patent Application Publication
(10) Pub. No.: US 2002/0084549 A1
(43) Pub. Date: Jul. 4, 2002

(54) Method of making non-polluting products

(76) Inventor: Kuo-Chen Yang, Taichung City (TW)

Correspondence Address: WEBB ZIESENHEIM LOGSDON ORKIN & HANSON P.C., 700 Koppers Building, 436 Seventh Avenue, Pittsburgh, PA, 15219-1818, US

(21) Appl. No.: 09/753,972

(22) Filed: Jan. 3, 2001

(51) Int. Cl. B29B 13/10; B29B 7/00

(52) U.S. Cl. 264/140; 264/349

(57) ABSTRACT

A method of making a non-polluting product includes the steps of: (a) obtaining an agricultural fibrous waste material; (b) drying the fibrous waste material; (c) grinding the fibrous waste material to form a powder; (d) mixing the powder with a binder in a mixer to form a mixture, the binder including polyglycol, cellulose and formaldehyde; and (e) forming the mixture into the product. The product produced by the method is a non-polluting inexpensive product since agricultural waste, which is recycled, can decompose naturally without leaving any toxic residue.

### BACKGROUND OF THE INVENTION

1. Field of the Invention

The invention relates to a method of making non-polluting molded products, more particularly to a method of making non-polluting containers, such as caskets, disposable food containers, etc., by using fibrous agricultural waste and a binder which is environmentally safe.

2. Description of the Related Art

A conventional casket generally uses a large amount of wood as a main raw material, thereby resulting in a very high production cost and in harm to the environment due to extensive felling of numerous trees.

Moreover, the raw material for making conventional disposable food containers includes plastic and paper material. Disadvantages arise in that the plastic material can not decompose naturally and will produce toxic gases during burning, and that the paper material does not have a good water and oil resistance and entails a relatively high production cost.

### SUMMARY OF THE INVENTION

An object of the present invention is to provide a method of making non-polluting inexpensive products by which agricultural waste is disposed by recycling.

Another object of the present invention is to provide a method of making non-polluting inexpensive products which can decompose naturally without leaving any toxic residue.

According to this invention, the method of making a non-polluting product comprises the steps of: (a) obtaining an agricultural fibrous waste material; (b) drying the fibrous waste material; (c) grinding the fibrous waste material to form a powder; (d) mixing the powder with a binder in a mixer to form a mixture, the binder including polyglycol, cellulose and formaldehyde; and (e) forming the mixture into the product.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is a perspective view showing a casket product made according to this invention;

FIG. 2 is a perspective view showing another casket product made according to this invention; and

FIG. 3 is a side view showing a bone ash urn product made according to this invention.

### DETAILED DESCRIPTION OF THE PREFERRED EMBODIMENTS

A first embodiment of the method according to the present invention comprises the first step of obtaining fibrous wastes of agricultural products which may be selected from the group consisting of plant's stems (e.g. rice stem, wheat stem, sorghum stem, etc.), crop shells (e.g. rice shell, wheat shell, sorghum shell, etc.), residues of vegetables (e.g. residues of corncob, sugar canes, and beans), wood shavings, and saw dusts. In this embodiment, plants' stems are selected as a main component of the materials used in the method. The plants' stems are subjected to drying which may be carried out via a centrifugal drying machine, or a sun drying method. The dried stems are ground to form a powder having 40-120 mesh.

The powder formed after grinding is fed into a mixer for mixing with a binder to form a mixture. The mixing is carried out at a high speed of 2500 rpm-3500 rpm for 15-30 min. The binder used in the present invention is prepared from polyglycol, cellulose and formaldehyde. Preferably, the binder includes 5-15% by weight of polyethyleneglycol, 5-15% by weight of cellulose, and 75-85% by weight of formaldehyde. This binder component is further mixed with a sulfate, a stearate and water. In an example, 10% by weight of polyethyleneglycol and 10% by weight of cellulose are mixed with 80% by weight of formaldehyle to form a main binder component. About 22% by weight of the aforesaid main binder component is mixed with 4% by weight of a sulfate, 4% by weight of a stearate, 12% by weight of water, and 56% by weight of the powder of the fibrous waste material. The sulfate may be barium sulfate, iron sulfate, zinc sulfate, manganese sulfate or chromium sulfate. The stearate may be magnesium stearate, calcium stearate, zinc stearate, aluminum stearate, or barium stearate.

The mixture in the mixer is sent into a mold and is molded under high pressure and temperature (about 185-200° C.). The resulting product is released from the mold after being cooled and is then air-dried. Finally, the molded product is coated with a paint. According to the present invention, various forms of containers may be produced.

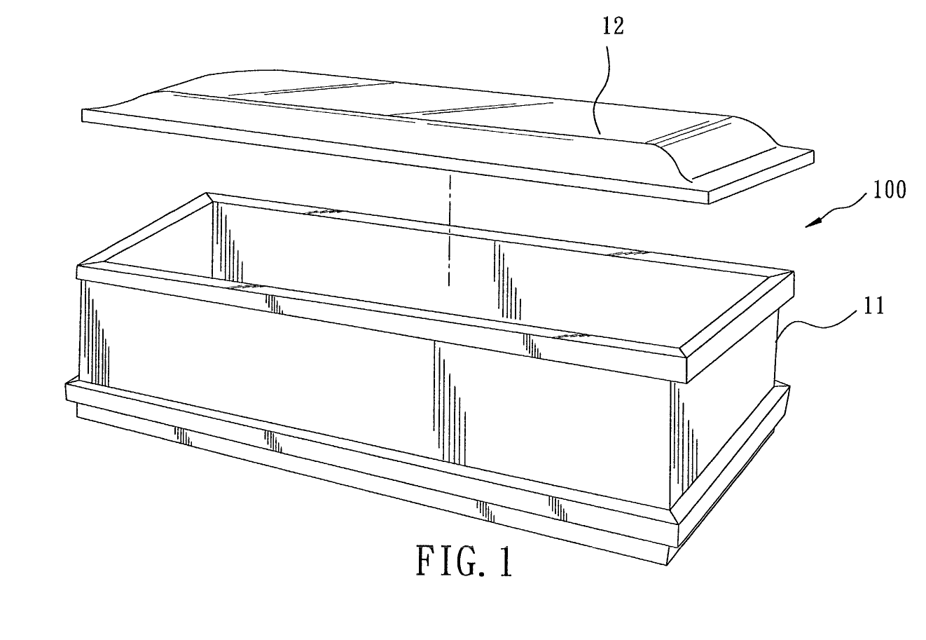

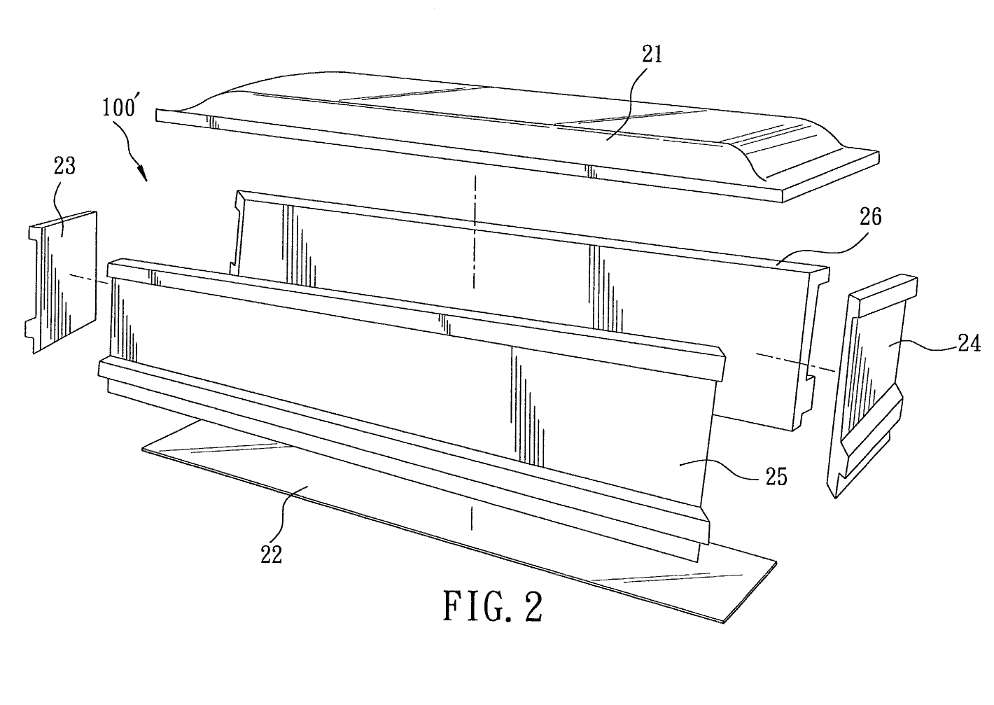

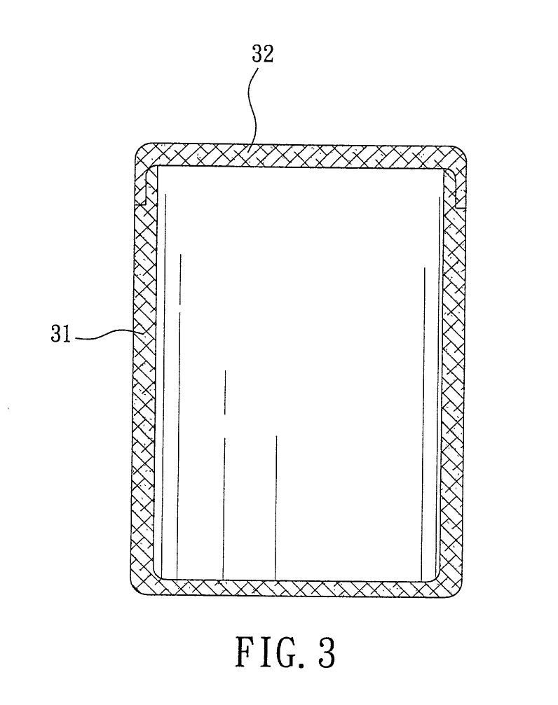

Referring to FIG. 1, a casket 100 produced according to the present invention includes a one-piece molded casket body 11, and a cover 12. Referring to FIG. 2, a casket 100′ is formed by assembling a top panel 21, a bottom panel 22, a front panel 23, a rear panel 24, a right panel 25, and a left panel 26, all of which are produced according to the method of the present invention. The aforesaid components may be assembled by adhesive bonding or by using fasteners, such as nails or screws. Referring to FIG. 3, the method of the present invention may be used to produce a bone ash urn 31 for containing bone ash, and a lid 32 for closing the open top of the bone ash urn 31.

The aforesaid method of the present invention provides the following advantages:

1. As a main raw material used in the present invention can be obtained easily from agricultural wastes, products can be produced at relatively low costs in the present invention. The agricultural wastes may be selected according to the seasons and sources available locally.

2. The products produced by the present invention can decompose naturally without leaving any polluting residue. In addition, the products can exhibit good hardness and do not involve any toxic or polluting substance harmful to environment.

3. After the products are buried in the soil, they can decompose into organic materials usable as a fertilizer.

4. As the present invention produces substitutes for wooden caskets that are usually made of hard woods, it not only saves the consumption of hard woods, but also offers low-cost caskets.

5. As agricultural wastes are used as a main raw material, aside from the benefit of waste recycling, environmental problems due to extensive felling of numerous trees are also avoided.

6. The casket made according to the present invention does not produce any polluting gas during cremation.

A second embodiment of the present invention is directed to the production of food containers. Like the previous embodiment, the agricultural fibrous waste material used in this embodiment may be selected from the group consisting of plant's stems (such as rice stems, wheat stems, corn stems, etc.), crop shells (such as rice shell, wheat shell, sorghum shell, etc.), residues of vegetables (such as residues of corncob, sugar cane, beans, etc.), wood shavings and saw dust. Firstly, the selected fibrous waste material is washed in order to remove dust and other impurities. After washing, the fibrous waste material is dried in a centrifugal drying machine. Alternatively, sun drying may be employed for drying the waste material. The dried waste material is then subjected to grinding to form a powder having a size of 80-120 mesh.

The powder as obtained is mixed in a mixer with starch (such as those obtained from cereal grains, e.g. corn starch, potato starch, etc,), polyglycol (such as polyethyleneglycol), cellulose, formaldehyde, a sulfate, a stearate, a skin forming agent, and water. In an example, the aforesaid ingredients are prepared as follows: Firstly, 10% by weight of polyethyleneglycol, 10% by weight of cellulose, and 80% by weight of formaldehyde are mixed together to form a unique binder according to the present invention, which is edible. The skin forming agent is prepared by mixing 60% by weight of the aforesaid binder with 20% by weight of calcium chloride and 20% by weight of alumina. Then, 84% by weight of the powder is mixed with 2% by weight of starch, 0.9% by weight of the unique binder, 0.05% by weight of a sulfate, 0.05% by weight of a stearate, 1% by weight of the skin forming agent, and 12% by weight of water.

The sulfate used in the invention may be barium sulfate, iron sulfate, zinc sulfate, manganese sulfate or chromium sulfate. The stearate may be magnesium stearate, calcium stearate, zinc stearate, aluminum stearate, or barium stearate.

After mixing the ingredients in the mixer, the resulting mixture is molded in a compression mold under high pressure and high temperature (e.g. 120° C.-185° C.) for about 7 sec to 50 sec. Subsequently, the molded product is dried and sterilized using ultraviolet rays. If the fibrous waste material undergoes a de-coloring process and the molded product is colored and patterned, drying and sterilizing may be done a second time before coloring and patterning.

Asides from the elimination of the environmental and pollution problems as described hereinbefore, the method of the second embodiment further offers the following effects:

1. The products produced by the method of the second embodiment are resistant to water and oil within six hours, at high temperatures of up to 130° C.

2. When buried in the soil, the products can decompose into organic materials usable as fertilizers within three months.

3. When dumped in water, the products can decompose within a short period to form fodder for aquatic life forms.

While the present invention has been described in connection with what is considered the most practical and preferred embodiments, it is understood that this invention is not limited to the disclosed embodiments but is intended to cover various arrangements included within the spirit and scope of the broadest interpretations and equivalent arrangements.

I claim:

1. A method of making a non-polluting product comprising:
(a) obtaining an agricultural fibrous waste material;
(b) drying the fibrous waste material;
(c) grinding the fibrous waste material to form a powder;
(d) mixing the powder with a binder in a mixer to form a mixture, the binder including polyglycol, cellulose and formaldehyde; and
(e) forming the mixture into the product.

2. The method of claim 1, wherein the agricultural fibrous waste material is selected from the group consisting of plants' stems, crop shells, residues of vegetables, wood shavings, and sawdust.

3. The method of claim 2, wherein the powder has a size of 40-120 mesh.

4. The method of claim 2, wherein the polyglycol is polyethyleneglycol.

5. The method of claim 4, wherein a stearate, a sulfate, and water are added to the mixer to form the mixture.

6. The method of claim 5, wherein the binder includes 515% by weight of polyethyleneglycol, 5-15% by weight of cellulose, and 75-85% by weight of formaldehyde.

7. The method of claim 5, wherein starch is added to the mixer to form the mixture.

8. The method of claim 7, wherein the binder includes 5-15% by weight of polyethyleneglycol, 5-15% by weight of cellulose, and 75-85% by weight of formaldehyde.

9. The method of claim 8, wherein a skin forming agent is added to the mixer to form the mixture, the skin forming agent being prepared by mixing the binder with calcium and alumina prior to adding the binder.

10. The method of claim 5, wherein the mixture is molded in a mold to form a one-piece casket body.

11. The method of claim 5, wherein the mixture is molded in a mold to form panel components of a casket, which includes a top panel, a bottom panel, a front panel, a rear panel, a left panel, and a right panel, the panel components being assembled to form the casket.

12. The method of claim 5, wherein the mixture is molded in a mold to form a bone ash urn.

13. The method of claim 9, wherein the mixture is molded in a mold to form a food container.
